(19) United States
(12) Patent Application Publication
(10) Pub. No.: US 2010/0272139 A1
(43) Pub. Date: Oct. 28, 2010

(54) DRIVING CIRCUIT FOR DRIVING LASER DIODE AND METHOD FOR CONTROLLING LASER POWERS OF LASER DIODE

(75) Inventors: Kuo-Ting Hsin, Hsinchu County (TW); Chao-Ming Huang, Hsin-Chu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/428,545

(22) Filed: Apr. 23, 2009

(51) Int. Cl. H01S 3/10; H01S 3/00

(52) U.S. Cl. 372/38.02; 372/38.07

(57) ABSTRACT

The invention provides a driving circuit for driving a laser diode of a pickup head. In one embodiment, the driving circuit comprises an automatic power control (APC) module, a clamp value determination unit, and a clamp circuit. The automatic power control module generates at least one power control signal. The clamp value determination unit dynamically determines at least one clamp value corresponding to the power control signal when the pickup head accesses an optical storage medium. The clamp circuit clamps the power control signal according to the clamp value to obtain a clamped power control signal. A driving signal for driving the laser diode can then be generated according to at least the clamped power control signal.

### BACKGROUND OF THE INVENTION

1. Field of the Invention

The invention relates to laser diodes, and more particularly to controlling of laser powers of laser diodes.

2. Description of the Related Art

A pickup head of an optical disk drive emits a laserbeam onto a surface of an optical disk to write data thereto or read data therefrom. In order to guarantee the read/write quality, a pickup head of an optical disk drive must be capable of generating a laserbeam with a stable power level according to different functions of the optical disk drive.

An optical disk drive therefore must comprise an automatic power control (APC) module to maintain a stable power level for laserbeams emitted by a pickup head. Referring to FIG. 1, a schematic diagram of a relationship between an output voltage of an automatic power control module and a laserbeam power level is shown, wherein the output voltage of the automatic power control module controls the laserbeam power level. The relationship between the APC output voltage and the laserbeam power level changes with temperature of the pickup head. When the temperature of the pickup head is increased, the pickup head requires a higher driving signal level to emit a laserbeam of the same power level. For example, three lines of FIG. 1 respectively show the relationship between the APC output voltage and the laserbeam power level at three different temperatures T1, T2, and T3, wherein T3>T2>T1. When the temperature of pickup head is T1, the pickup head requires an APC output voltage V1 to emit a laserbeam with a target power level P_{target}. When the temperature of the pickup head is increased to T2, the pickup head requires a higher APC output voltage V2 to emit a laserbeam with the same target power level P_{target}. When the temperature of the pickup head is further increased to T3, the pickup head requires a further higher APC output voltage V3 to emit a laserbeam with the same target power level P_{target}. Thus, the automatic power control module has to output different voltages V1, V2, and V3 at different temperatures T1, T2, and T3 to generate a laserbeam with the same power level P_{target}. Because the laserbeam gives off heat that increases temperature of the pickup head, the automatic power control module must frequently raises its output voltage to maintain a stable power level for laserbeams. However, the power level for laserbeam cannot be raised unlimitedly; otherwise the laser diode would be burned out due to over current situation.

To protect the laser diode from break down, clamping circuits are generally utilized to limit the output control voltages of the APC. Referring to FIG. 2A, a block diagram of an optical disk drive 300 with an automatic power control module 310 and clamps 322, 324, 326, and 328 is shown. In addition to the automatic power control module 310 and clamps 322, 324, 326, and 328, the optical disk drive 300 comprises a pickup head 302, a sample and hold circuit 308, an analog-to-digital converter (ADC) 309, four digital-to-analog converters (DACs) 323, 325, 327, and 329, four resistors 312, 314, 316, and 318, and a laser diode driver 320. The pickup head 302 comprises a laser diode (LD) 304 and a front monitor diode (FMD) 306. The laser diode 304 generates a laserbeam L with a power level controlled by a driving current I. The laserbeam L is emitted onto a surface of an optical disk 350. The front monitor diode 306 then detects laserbeam L to generate an output signal S, and the sample and hold circuit 308 then samples the output signal S to obtain a sampled signal S′. The ADC 309 converts the sampled signal S′ from analog to digital to obtain a digital signal S″.

Because the digital signal S″ indicates the power level of the laserbeam, the automatic power control module 310 then generates a plurality of power control signals K₁, K₂, K₃, and K₄ according to the digital signal S″. Each power control signal corresponds to a specific channel such as a reading channel, an erase channel, an writing channel 1, or a writing channel 2. Please refer to FIG. 2B, which shows an example of a write pulse constituted by four laserbeam power level respectively provided by the reading channel, the erase channel, the writing channel 1, and the writing channel 2. The reading channel, the erase channel, the writing channel 1, and the writing channel 2 respectively represent an incremental power level of the laserbeam L. When some of the channels are enabled, the laserdiode 304 increases the power level of the laserbeam L by the incremental power levels corresponding to the enabled channels. For example, during a period T1, the read channel and the erase channel are enabled to generate a laserbeam with the power level L1. During periods T2 and T4, all four channels are enabled to generate a laserbeam with the power levels L2 and L4. During a period T3, the read channel, the erase channel, and the writing channel 1 are enabled to generate a laserbeam with the power level L3. During a period T5, the read channel is enabled to generate a laserbeam with the power level L5. The write pulse sequentially having power levels of L1, L2, L3, L4, and L5 for recording data on a BDR disk is therefore generated.

The clamp circuits 322, 324, 326, and 328 then clamp the power control signals K₁, K₂, K₃, and K₄ to obtain the power control signals K₁′, K₂′, K₃′, and K₄′ with level lower than the corresponding clamp values. The DACs 323, 325, 327, and 329 then convert the power control signals K₁′, K₂′, K₃′, and K₄′ from digital to analog to obtain power control signals K₁″, K₂″, K₃″, and K₄″. The resistors 312, 314, 316, and 318 then converts the power control signals from voltages to currents to obtain power control signals I₁, I₂, I₃, and I₄. The laser diode driver 320 then generates a driving current I according to the power control signals I₁, I₂, I₃, and I₄, and the laser diode 304 further adjusts a power level of the laserbeam L according to the driving current I. Thus, the driving current I is clamped and will not burn out the laser diode 304.

Each clamp has a fixed clamp value, which is set as an output voltage of the APC required for the maximum laser power at the highest temperature. This is because, if the clamp circuits 322, 324, 326, and 328 have low clamp values, the power control signals K₁′, K₂′, K₃′, and K₄′ are clamped to the low clamp values to generate a reduced driving current I, the laser diode 304 would not generate a laserbeam with a sufficient power level when the temperature is high; if the clamp circuits 322, 324, 326, and 328 have high clamp values, the power control signals K₁′, K₂′, K₃′, and K₄′ are clamped according to the high clamp values, the laser diode driver 320 would generate a large driving current I and burn out the laser diode 304 when the temperature is low.

As the optical access techniques develop, however, the conventional clamp mechanism that utilizes fixed clamp values is inadequate. For example, double-layer disks and increased recording speed both complicate the design of the disk drive. Since higher laser power is requested and the output range of the APC becomes larger, it is difficult to protect the laser diode 304 by fixed clamp values.

### BRIEF SUMMARY OF THE INVENTION

The invention provides a driving circuit for driving a laser diode of a pickup head. In one embodiment, the driving circuit comprises an automatic power control (APC) module, a clamp value determination unit, and a clamp circuit. The automatic power control module generates at least one power control signal. The clamp value determination unit dynamically determines at least one clamp value corresponding to the power control signal when the pickup head accesses an optical storage medium. The clamp circuit clamps the power control signal according to the clamp value to obtain a clamped power control signal. A driving signal for driving the laser diode can then be generated according to at least the clamped power control signal.

The invention provides a driving circuit for driving a laser diode of a pickup head. In one embodiment, the optical disk drive comprises an automatic power control (APC) module, a determination unit, and a voltage-to-current transforming unit. The automatic power control module generates at least one power control signal. The determination unit dynamically determines a transformation characteristic when the pickup head accesses an optical storage medium. The voltage-to-current transforming circuit transforms the power control signal from a voltage format to a current format according to the transformation characteristic to generate a transformed power control signal. A driving signal for driving the laser diode can then be generated according to at least the transformed power control signal.

The invention provides a method for controlling a laser power of a laser diode of a pickup head. First, at least one power control signal is generated. At least one clamp value corresponding to the power control signal is then dynamically determined when the pickup head accesses an optical storage medium. The power control signal is then clamped according to the clamp value to obtain a clamped power control signal.

The invention also provides a method for controlling laser power of a laser diode of a pickup head. First, at least one power control signal is generated. A transformation characteristic is then dynamically determined when the pickup head accesses an optical storage medium. The power control signal is then transformed from a voltage format to a current format according to the transformation characteristic to generate a transformed power control signal.

The invention also provides a driving circuit for driving a laser diode. In one embodiment, the driving circuit comprises an automatic power control (APC) module, a clamp value determination unit, and a clamp circuit. First, the automatic power control module generates at least one power control signal. The clamp value determination unit then determines at least one clamp value corresponding to the power control signal according to temperature of the laser diode. The clamp circuit then clamps the power control signal according to the clamp value to obtain a clamped power control signal.

The invention also provides a driving circuit for driving a laser diode. In one embodiment, the driving circuit comprises an automatic power control (APC) module, a clamp value determination unit, and a clamp circuit. The automatic power control module generates at least one power control signal. The clamp value determination unit determines at least one clamp value corresponding to the power control signal according to a target recording power. The clamp circuit clamps the power control signal according to the clamp value to obtain a clamped power control signal.

Because the clamp value and/or the V-to-I transformation characteristic is dynamically adjusted during access of an optical storage medium, the driving signal for driving the laser diode can be properly limited at different temperatures and different recording modes. For example, when the temperature of the laser diode is low, the clamp value is set lower to protect the laser diode from burning out; when the temperature of the laser diode is high, the clamp value is set higher to provide sufficient driving power. The performance of reading/writing an optical storage medium can therefore be improved.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a relationship between an output voltage of an automatic power control module and a laserbeam power level;

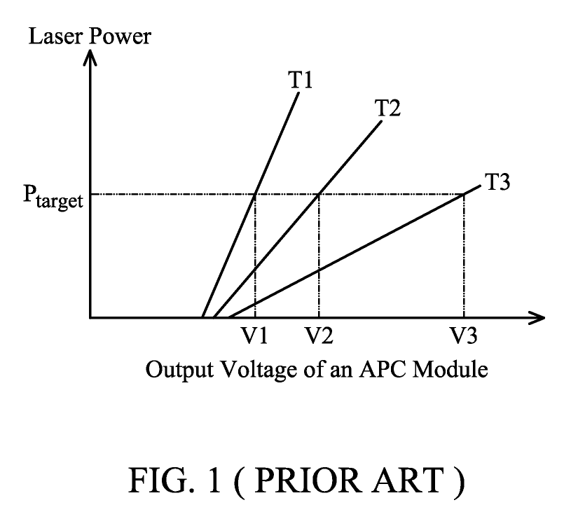

FIG. 2A is a block diagram of an conventional optical disk drive with a digital automatic power control module;

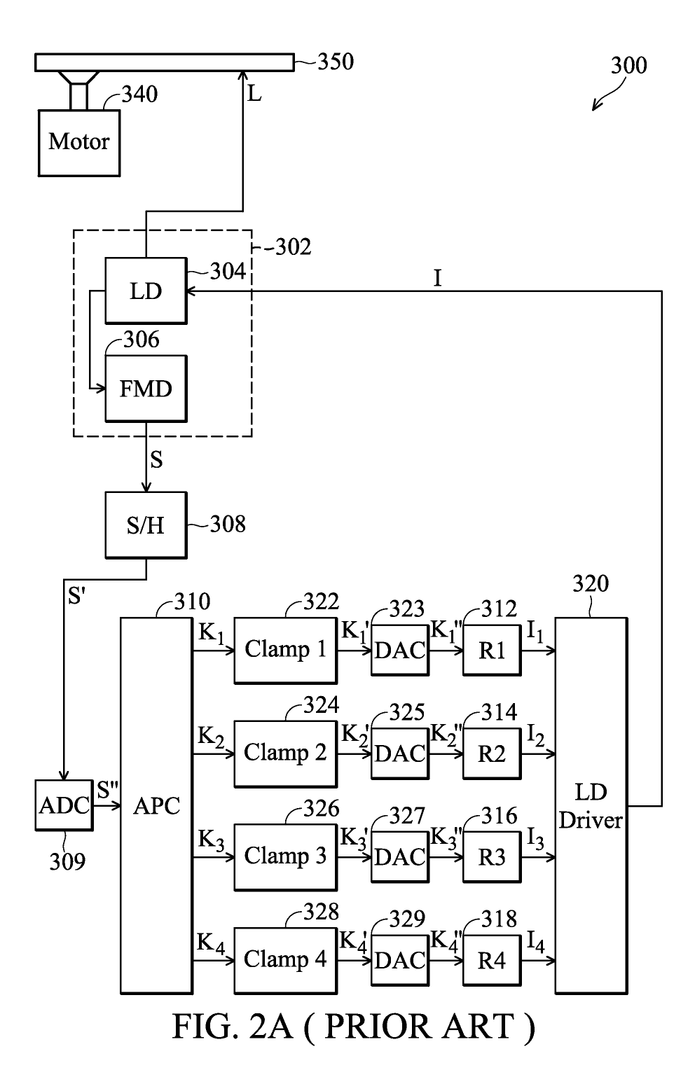

FIG. 2B shows an example of a write pulse constituted by four laserbeam power level respectively provided by the reading channel, the erase channel, the writing channel 1, and the writing channel 2;

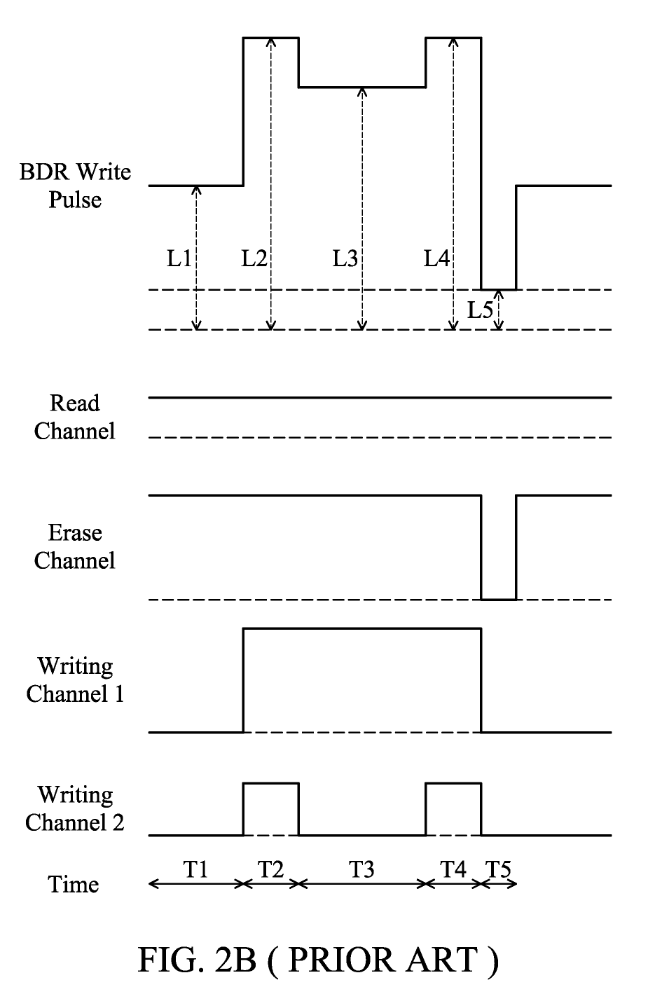

FIG. 3 is a block diagram of an embodiment of an optical disk drive with a digital automatic power control module according to the invention;

FIG. 4 is a block diagram of an embodiment of an optical disk drive with an analog automatic power control module according to the invention;

FIG. 5 is a block diagram of another embodiment of an optical disk drive with a digital automatic power control module according to the invention;

FIG. 6 is a schematic diagram of determination of clamp values according to linear interpolation;

FIG. 7 is a block diagram of another embodiment of an optical disk drive with a digital automatic power control module according to the invention;

FIG. 8 is a block diagram of another embodiment of an optical disk drive with an analog automatic power control module according to the invention;

FIG. 9 is a schematic diagram of determination of clamp values according to a recording speed and temperature;

FIG. 10 is a block diagram of another embodiment of an optical disk drive with a digital automatic power control module according to the invention; and

FIG. 11 is a block diagram of another embodiment of an optical disk drive with an analog automatic power control module according to the invention;

FIG. 12 is a block diagram of an optical disk drive according to another embodiment of the present invention; and

FIG. 13 is a block diagram of another optical disk drive which combines the clamp value adjustment with the transformation characteristic adjustment according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

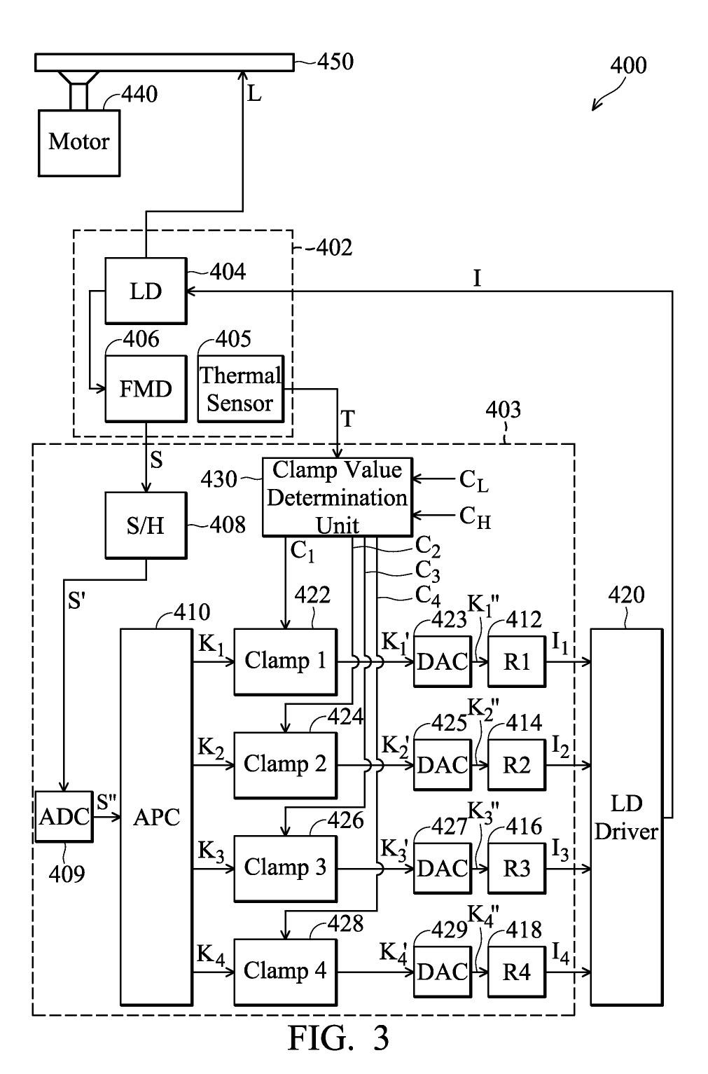

Referring to FIG. 3, a block diagram of an embodiment of an optical disk drive 400 according to the invention is shown. The optical disk drive 400 comprises a pickup head 402 comprising a laser diode (LD) 404, a driving circuit 403 for generating power control signals, and a laser diode driver 420 for driving and controlling the laser power of the laser diode 404 according to the power control signals. The driving circuit 403 comprises a sample and hold circuit 408, an analog-to-digital converter (ADC) 409, an automatic power control (APC) module 410, a plurality of clamp circuits 422, 424, 426, and 428, a plurality of digital-to-analog converters (DAC) 423, 425, 427, and 429, a plurality of resistors 412, 414, 416, and 418, and a clamp value determination unit 430. In one embodiment, the pickup head 402 further comprises a front monitor diode (FMD) 406, and a thermal sensor 405. The laser diode 404 generates a laserbeam L with a power level controlled by a driving current I. The front monitor diode 406 detects the strength of laserbeam L to obtain an output signal S having an amplitude in proportional to the power level of the laserbeam L. The sample and hold circuit 408 then samples the output signal S to obtain a sampled signal S′, and the analog-to-digital converter 409 then converts the sampled signal S′ from analog format to digital format to obtain a digital signal S″.

The automatic power control module 410 then generates a plurality of power control signals K₁, K₂, K₃, and K₄ by comparing the digital signal S″ with a target power level for keeping the laser power of the laserbeam L stable at the target power level. Each of the power control signals K₁, K₂, K₃, and K₄ corresponds to a specific channel, such as a read channel, an erase channel, a writing channel 1, and a writing channel 2. The thermal sensor 405 detects temperature of the pickup head 402 to obtain a temperature signal T. The clamp value determination unit 430 then determines a plurality of clamp values C₁, C₂, C₃, and C₄ of the clamp circuits 422, 424, 426, and 428 according to the temperature signal T. The clamp circuits 422, 424, 426, and 428 then respectively clamp the power control signals K₁, K₂, K₃, and K₄ according to the clamp values C₁, C₂, C₃, and C₄ to generate plurality of clamped power control signals K₁′, K₂′, K₃′, and K₄′ with magnitudes equal to or lower than the clamp values C₁, C₂, C₃, and C₄. The digital-to-analog converters 423, 425, 427, and 429 then converts the clamped power control signals K₁′, K₂′, K₃′, and K₄′ from digital to analog to obtain analog power control signals K₁″, K₂″, K₃″, and K₄″. The resistors 412, 414, 416, and 418 then converts the power control signals K₁″, K₂″, K₃″, and K₄″ from voltages to currents to obtain power control signals I₁, I₂, I₃, and I₄.

The laser diode driver 420 then generates the driving current I according to the power control signals I₁, I₂, I₃, and I₄. Because the magnitudes of the power control signals I₁, I₂, I₃, and I₄ are clamped by the clamp circuits 422, 424, 426, and 428, the laser diode driver 420 does not generate a driving current I with an excessive level that would burn out the laser diode 404. The laser diode 404 therefore is ensured against the risk of being burned out. In addition, the clamp value determination unit 430 dynamically adjusts the clamp values C₁, C₂, C₃, and C₄ according to currently detected temperature T of the pickup head 402 during the access (reading, writing, etc.) of the optical storage medium 450. In one embodiment, the clamp value determination unit 430 increases the clamp values C₁, C₂, C₃, and C₄ when the temperature T of the pickup head 402 gets higher, and decreases the clamp values C₁, C₂, C₃, and C₄ when the temperature T of the pickup head 402 gets lower. Since the automatic power control module 410 generates the power control signals K₁, K₂, K₃, and K₄ with high amplitudes at a high temperature, the clamped power control signals K₁′, K₂′, K₃′, and K₄′ are therefore clamped according to high clamp values C₁, C₂, C₃, and C₄ to direct the laser diode 404 to generate a laserbeam L with a sufficient power level. Since the automatic power control module 410 generates the power control signals K₁, K₂, K₃, and K₄ with low amplitudes at a low temperature, the clamped power control signals K₁′, K₂′, K₃′, and K₄′ are therefore clamped according to low clamp values C₁, C₂, C₃, and C₄ to prevent the laser diode 404 from burning out.

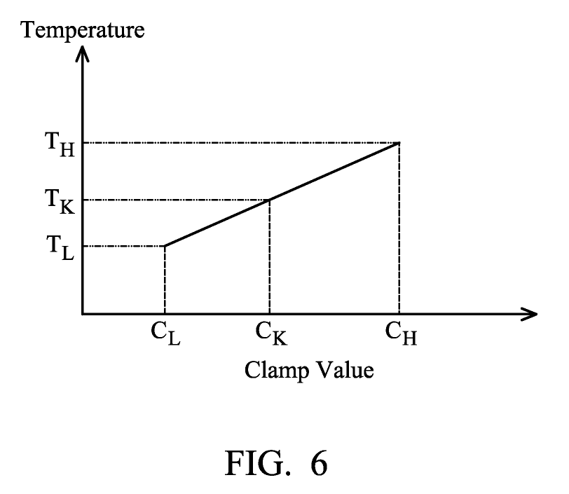

In one embodiment, the clamp value determination unit 430 determines the clamp values C₁, C₂, C₃, and C₄ of the clamp circuits 422, 424, 426, and 428 according to linear interpolation. Referring to FIG. 6, a schematic diagram of determination of clamp values according to linear interpolation is shown. In addition to the temperature signal T, the clamp value determination unit 430 further refers to a predetermined clamp value C_{L} corresponding to a low temperature T_{L} and a predetermined clamp value C_{H} corresponding to a high temperature T_{H}. Assume that the temperature signal T indicates that the current temperature of the pickup head 402 is T_{K}. The clamp value determination unit 430 then determines a clamp value C_{K} corresponding to the current temperature T_{K} according to linear interpolation based on the predetermined clamp values C_{L} and C_{H}. In one embodiment, the clamp value determination unit 430 determines the clamp value C_{K} according to the following algorithm:

$${C}_{k} = {C}_{L} + \frac{{C}_{H} - {C}_{L}}{{T}_{H} - {T}_{L}} \times ( {T}_{K} - {T}_{L} ) .$$

The predetermined clamp value C_{L} and the predetermined clamp value C_{H} may be obtained by the following steps. Output voltage of the APC module 410 corresponding to the maximum laser power for each channel at the low temperature T_{L} (e.g. 0) is first measured. The measured output voltage added by a margin voltage is regarded as the predetermined clamp value C_{L}. Likewise, through measuring output voltage of the APC module 410 corresponding to the maximum laser power for each channel at the high temperature T_{H} (e.g. 50) and add a margin voltage to the measured output voltage, the predetermined clamp value C_{H} is obtained.

In another embodiment, a list of predetermined clamp values corresponding to a series of temperatures is pre-established in a lookup table, and the clamp value determination unit 430 determines the clamp values C₁, C₂, C₃, and C₄ by searching the lookup table for the clamp values C₁, C₂, C₃, and C₄ according to the temperature T.

For illustration simplicity, only one pair of predetermined clamp values C_{H} and C_{L} is shown in FIG. 3, however, considering that each power channel may have different path gain, a plurality of predetermined clamp values C_{H1}, C_{L1}, C_{H2}, C_{L2}, C_{H3}, C_{L3}, C_{H4} and C_{L4} may be utilized to generate the clamp values C₁, C₂, C₃, and C₄, respectively.

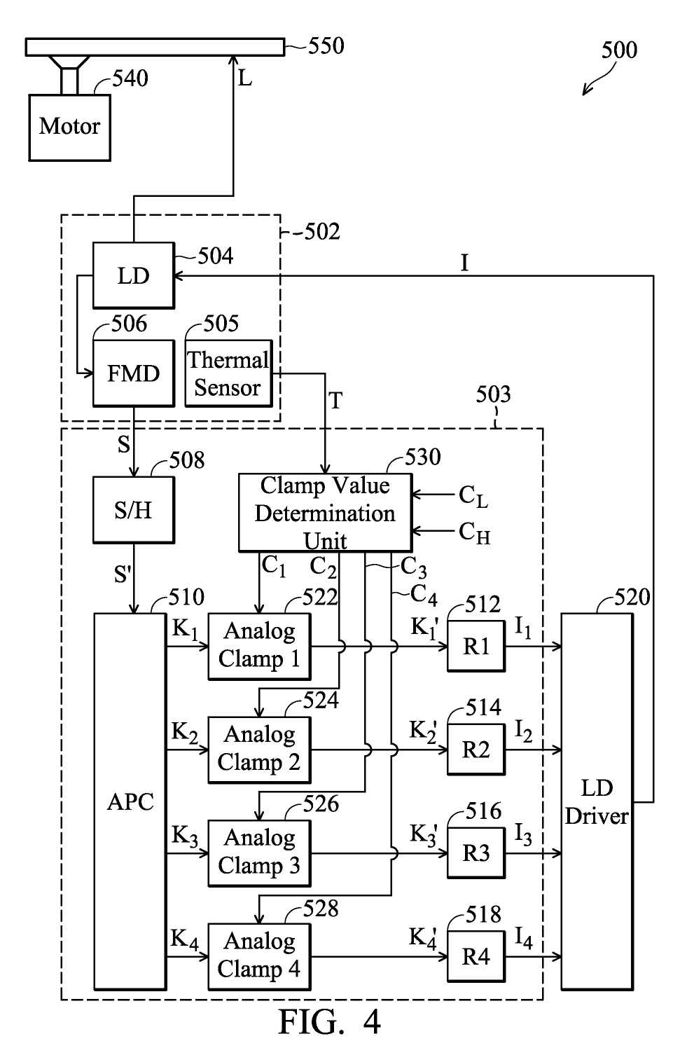

The automatic power control module 410 shown in FIG. 3 is a digital automatic power control module receiving a digital input and generating digital outputs. When the automatic power control module is an analog automatic power control module receiving an analog input and generating analog outputs, the signal clamping circuit structure of FIG. 3 still functions with a slight modification. Referring to FIG. 4, a block diagram of another embodiment of an optical disk drive 500 according to the invention is shown. The optical disk drive 500 comprises an analog automatic power control module 510 which directly receives an analog signal S′ from a sample and hold circuit 508 and outputs analog power control signals K₁, K₂, K₃, and K₄. After a thermal sensor 505 detects temperature T of the pickup head 502, a clamp value determination unit 530 determines a plurality of clamp values C₁, C₂, C₃, and C₄ of the analog clamp circuits 522, 524, 526, and 528 according to the temperature signal T, and the analog clamp circuits 522, 524, 526, and 528 then respectively clamp the analog power control signals K₁, K₂, K₃, and K₄ according to the clamp values C₁, C₂, C₃, and C₄ to generate a plurality of clamped power control signals K₁′, K₂′, K₃′, and K₄′ with magnitudes equal to or lower than the clamp values C₁, C₂, C₃, and C₄. The resistors 512, 514, 516, and 518 then directly receive the clamped power control signals K₁′, K₂′, K₃′, and K₄′ without digital-to-analog conversion.

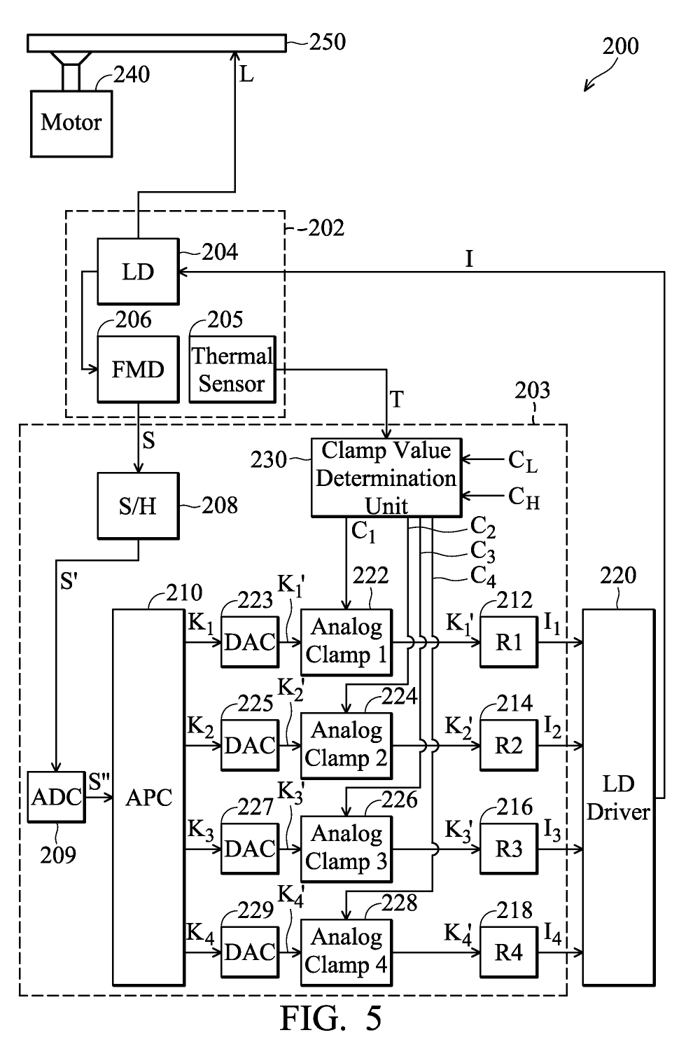

In another embodiment, as shown in FIG. 5, the analog clamps 222, 224, 226, and 228 are coupled between the DACs 223, 225, 227, and 229, and the LD driver 220. That is, the APC module 210 operates in digital domain, while the clamps 222-228 operate in analog domain.

When an optical disk drive emits a laserbeam to a surface of an optical disk to write data thereon, an intensity of the laserbeam is determined according to a recording speed. When the optical disk drive writes data with a high recording speed, the pickup head must generate a laserbeam with a high power level. When the optical disk drive writes data with a low recording speed, the pickup head must generate a laserbeam with a low power level. A laser diode driver therefore must increase a driving current when a recording speed of the optical disk drive is high, and decrease the driving current when a recording speed of the optical disk drive is low. Similarly, an automatic power control module must generate power control signals with high amplitudes when a recording speed of the optical disk drive is high, and generate power control signals with low amplitudes when a recording speed of the optical disk drive is low. Clamp circuits for clamping the power control signals therefore must have large clamp values when the recording speed is high and have small clamp values when the recording speed is low. A clamp value determination unit therefore must dynamically adjust the clamp values of the clamp circuits according to the recording speed of the optical disk drive.

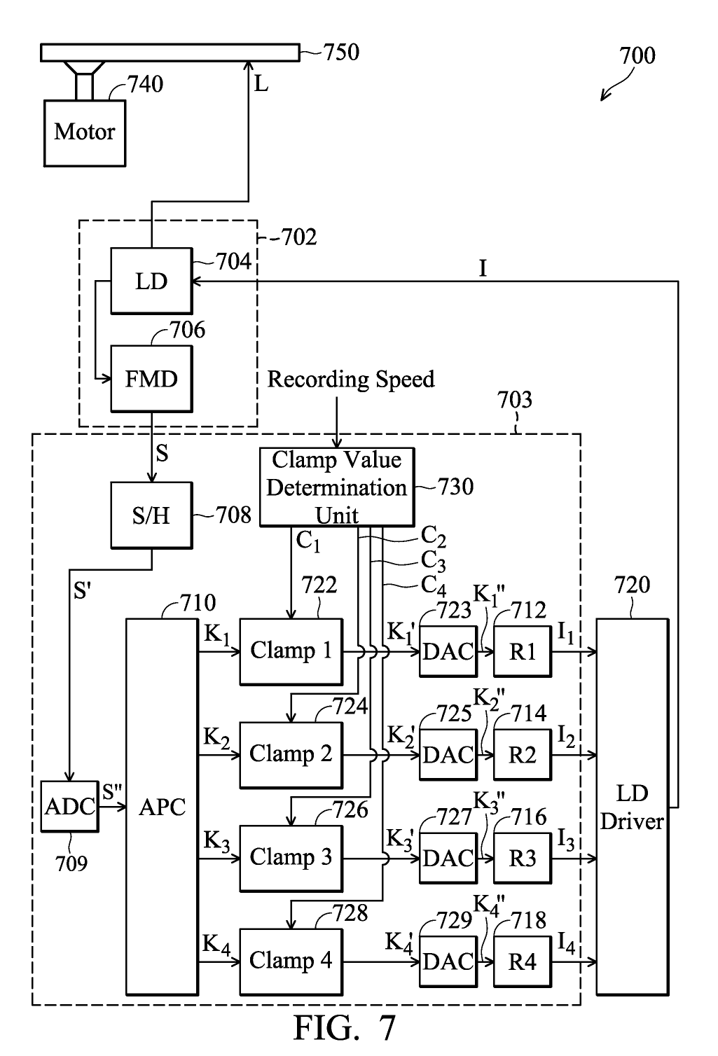

Referring to FIG. 7, a block diagram of another embodiment of an optical disk drive 700 according to the invention is shown. The optical disk drive 700 has a similar circuit structure with the optical disk drive 300 shown in FIG. 3. A clamp value determination unit 730 determines clamp values C₁, C₂, C₃, and C₄ of clamp circuits 722, 724, 726, and 728 according to a recording speed. The clamp circuits 722, 724, 726, and 728 then respectively clamp power control signals K₁, K₂, K₃, and K₄ generated by an automatic power control module 710 according to the clamp values C₁, C₂, C₃, and C₄ to generate clamped power control signals K₁′, K₂′, K₃′, and K₄′ with magnitudes equal to or lower than the clamp values C₁, C₂, C₃, and C₄. In one embodiment, the clamp value determination unit 730 determines the clamp values C₁, C₂, C₃, and C₄ according to linear interpolation. A predetermined clamp value C_{L} corresponding to a low recording speed S_{L} and a predetermined clamp value C_{H} corresponding to a high recording speed S_{H} are provided to the clamp value determination unit 730, and the clamp value determination unit 730 determines a clamp value C_{K} corresponding to the current recording speed S_{K} according to the following algorithm:

$${C}_{k} = {C}_{L} + \frac{{C}_{H} - {C}_{L}}{{S}_{H} - {S}_{L}} \times ( {S}_{K} - {S}_{L} ) .$$

The predetermined clamp value C_{L} and the predetermined clamp value C_{H} may be obtained by the following steps. Output voltage of the APC module 710 corresponding to the maximum laser power for each channel at the low recording speed S_{L} is first measured. The measured output voltage added by a margin voltage is regarded as the predetermined clamp value C_{L}. Likewise, through measuring output voltage of the APC module 710 corresponding to the maximum laser power for each channel at the high recording speed S_{H} and add a margin voltage to the measured output voltage, the predetermined clamp value C_{H} is obtained.

In another embodiment, the clamp value determination unit 730 determines the clamp values C₁, C₂, C₃, and C₄ by searching a lookup table for the clamp values C₁, C₂, C₃, and C₄ according to the recording speed, wherein the lookup table stores a list of predetermined clamp values corresponding to a plurality of recording speeds.

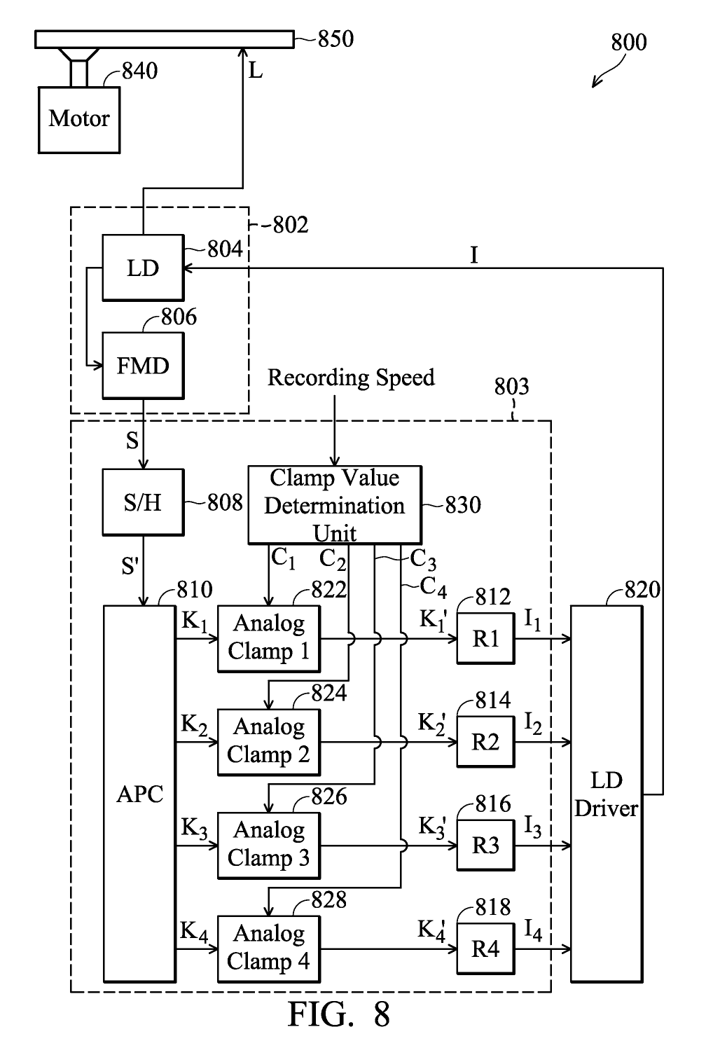

The digital-to-analog converters 723, 725, 727, and 729 then converts the clamped power control signals K₁′, K₂′, K₃′, and K₄′ from digital to analog to obtain analog power control signals K₁″, K₂″, K₃″, and K₄″. The resistors 712, 714, 716, and 718 then converts the power control signals K₁″, K₂″, K₃″, and K₄″ from voltages to currents to obtain power control signals I₁, I₂, I₃, and I₄. Finally, the laser diode driver 720 generates a driving current I according to the power control signals I₁, I₂, I₃, and I₄, and the laser diode 704 emits a laserbeam L with a power level controlled by the driving current I. When the automatic power control module is an analog automatic power control module, the same circuit structures function similarly with the digital automatic power control module. Referring to FIG. 8, a block diagram of another embodiment of an optical disk drive 800 with an analog automatic power control module 810 according to the invention is shown. A clamp value determination unit 830 determines clamp values C₁, C₂, C₃, and C₄ according to a recording speed for clamping the analog power control signals K₁, K₂, K₃, and K₄ output by the analog automatic power control module 810.

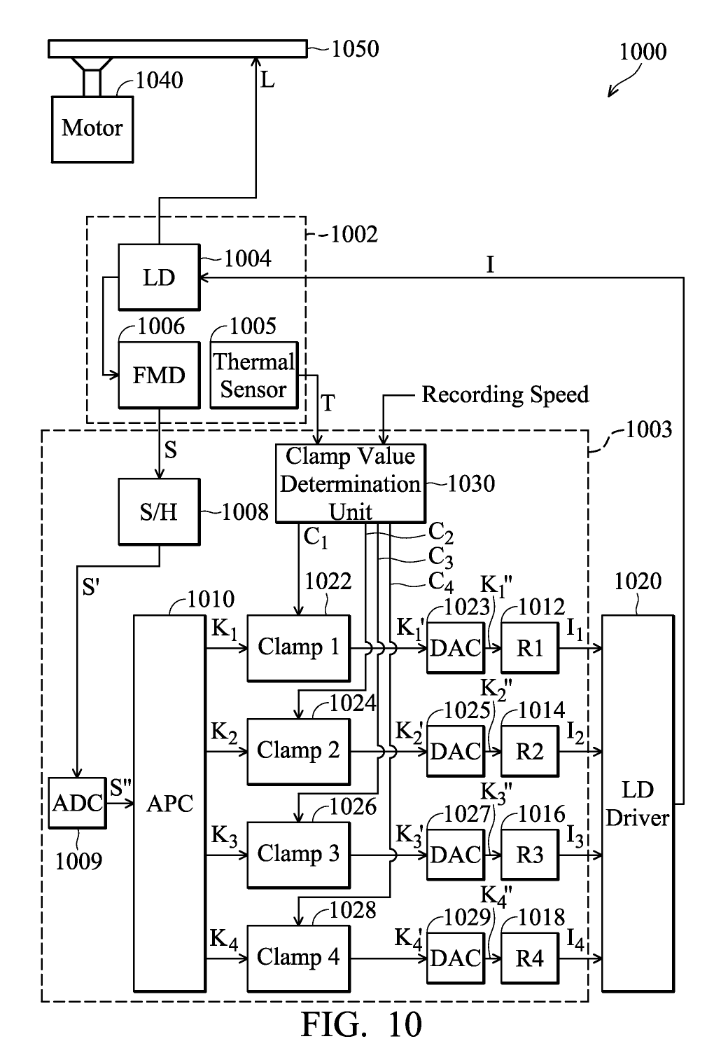

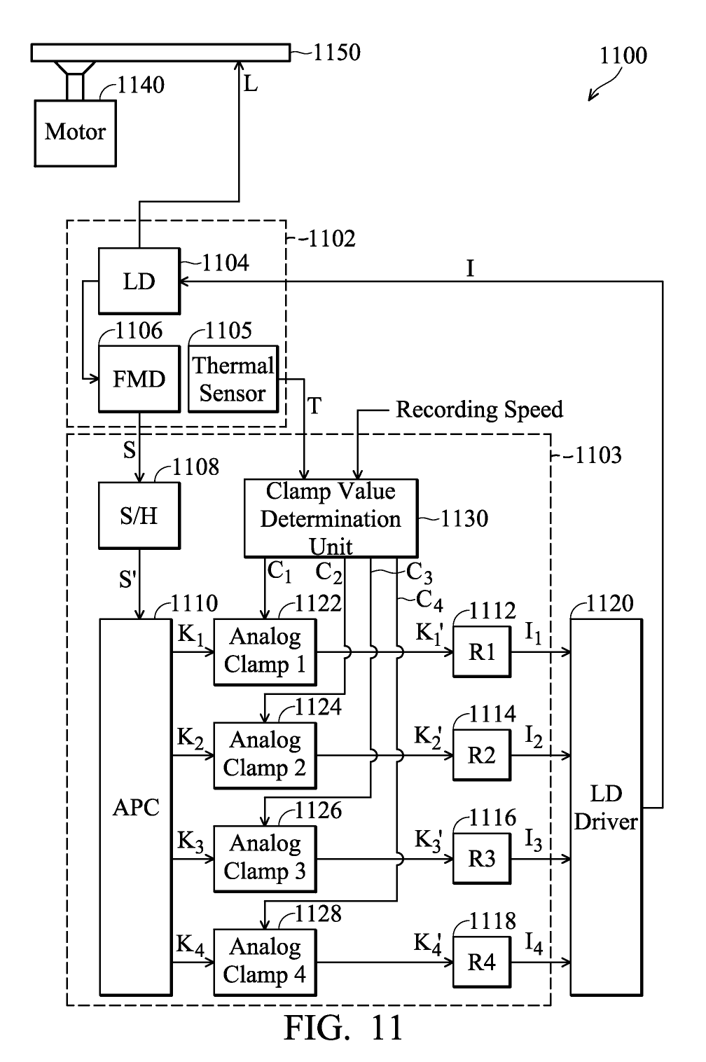

The embodiments of FIG. 3 and FIG. 7 can be combined together. In other words, clamp values for clamping output signals of an automatic power control module are determined according to both temperature and a recording speed. Referring to FIG. 10, a block diagram of another embodiment of an optical disk drive 1000 according to the invention is shown. A thermal sensor 1005 generates temperature signal T indicating temperature of a pickup head 1002. A clamp value determination unit 1030 then determines clamp values C₁, C₂, C₃, and C₄ according to the temperature T and a recording speed. A plurality of clamp circuits 1022, 1024, 1026, and 1028 then clamp power control signals K₁, K₂, K₃, and K₄ generated by a digital automatic power control module 1010 according to the clamp values C₁, C₂, C₃, and C₄. Similarly, the embodiments of FIG. 4 and FIG. 8 can be combined together. Referring to FIG. 11, a block diagram of another embodiment of an optical disk drive 1100 with an analog automatic power control module 1110 according to the invention is shown. The optical disk drive 1100 is similar to the optical disk drive 1000, except for omission of an analog-to-digital converter 1009 and digital-to-analog converters 1023, 1025, 1027, and 1029.

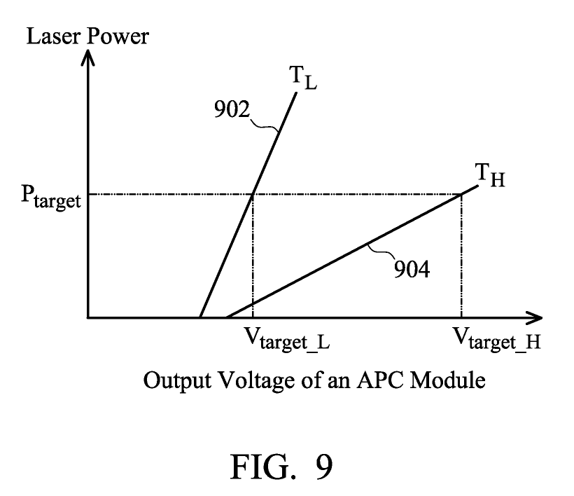

Referring to FIG. 9, a schematic diagram of determination of clamp values according to a recording speed and temperature is shown. Two lines 902 and 904 of FIG. 9 respectively indicate relationships between a laser power level and an output voltage of an automatic power control module at a low temperature T_{L} and a high temperature T_{H}. The clamp value determination unit 1030 first determines a target recording power level P_{target} corresponding to a recording speed of the optical disk drive 1000, which is defined by specifications of optical disk drives. The clamp value determination unit 1030 then determines a power control signal V_{target}_{_{—}}_{L} for generating a laserbeam with the target recording power level P_{target} at the low temperature T_{L} according to the relationship line 902, and determines a power control signal V_{target}_{_{—}}_{H} for generating a laserbeam with the target recording power level P_{target} at a high temperature T_{H} according to the relationship line 904. The clamp value determination unit 1030 then adds margin values to the power control signal V_{target}_{_{—}}_{L} and V_{target}_{_{—}}_{H} to obtain clamp values C_{L} and C_{H} respectively corresponding to the low temperature T_{L} and the high temperature T_{H}, and then determines a clamp value C_{K} corresponding to a current temperature T_{K} according to linear interpolation based on the clamp values C_{L} and C_{H} corresponding to the low temperature T_{L} and the high temperature T_{H}, as shown in FIG. 6. The clamp value C_{K} is therefore determined according to the current temperature T_{K} and the recording speed of the optical disk drive 1000. Similarly, in another embodiment, a table containing a list of predetermined clamp values corresponding to a series of temperatures and recording speeds may be pre-established, and the clamp value determination unit 1030 may determine the clamp value C_{K} by searching the lookup table according to the current temperature T_{K} and the recording speed.

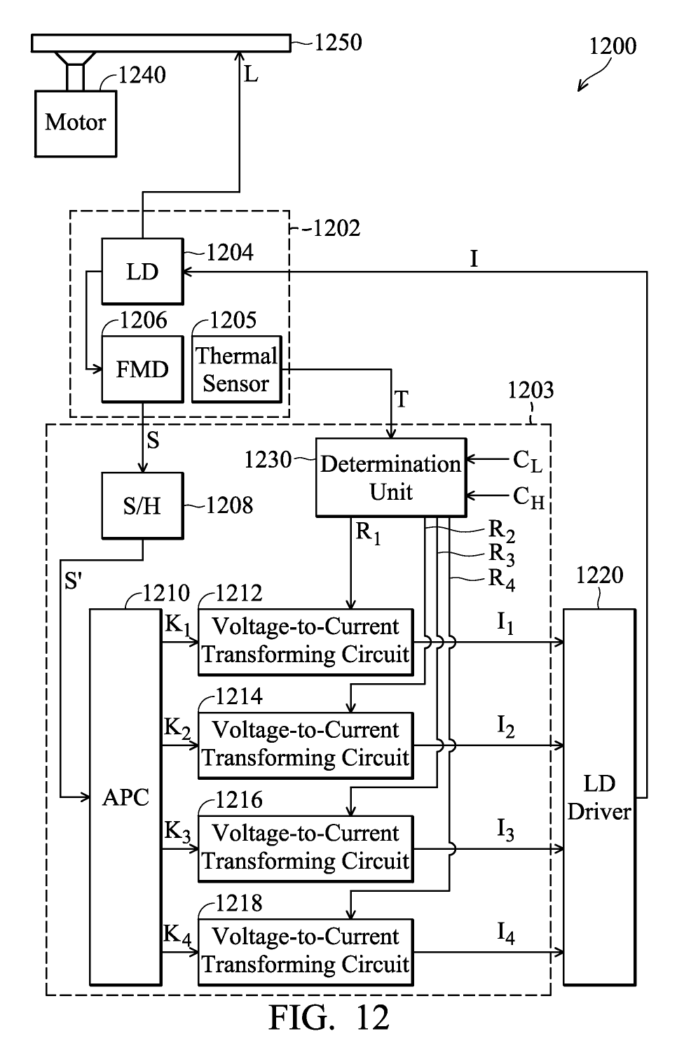

Please refer to FIG. 12, which shows a block diagram of an optical disk drive according to another embodiment of the present invention. In this embodiment, a determining unit 1230 is coupled to the pickup head 1202 and voltage-to-current transforming circuits 1212, 1214, 1216, and 1218. Each of the voltage-to-current transforming circuits 1212, 1214, 1216, and 1218 has a transformation characteristic R1˜R4 determining a voltage-to-current transformation relationship. The determining unit 1230 dynamically determines the transformation characteristics R1, R2, R3, and R4 when the pickup head 1202 accesses the optical storage medium (such as the optical disk 1250). The voltage-to-current transforming circuits 1212, 1214, 1216, and 1218 transforms the power control signals K1-K4 from a voltage format to a current format according to the transformation characteristics R1, R2, R3, and R4 to generate power control currents I1-I4. Then, the laser diode driver 1220 generates a driving signal I to drive the laser diode 1204 according to the power control currents I1-I4. In one embodiment, the voltage-to-current transforming circuits 1212, 1214, 1216, and 1218 comprise resistive elements, such as the resistors R1-R4 shown in FIG. 12, and the determining unit 430 dynamically determines the resistance of the resistors R1-R4 according to temperature T of the pickup head 1202, a recording speed, or a target recording power. For example, when the temperature of the pickup head 1202 is high, the resistance is adjusted to become lower to generate higher power control currents I1-I4, and when the temperature of the pickup head 1202 is low, the resistance is adjusted to become higher to generate lower power control currents I1-I4. In this way, the laser power can be controlled at different temperatures (or different recording speeds), and the laser diode 1204 can therefore be protected.

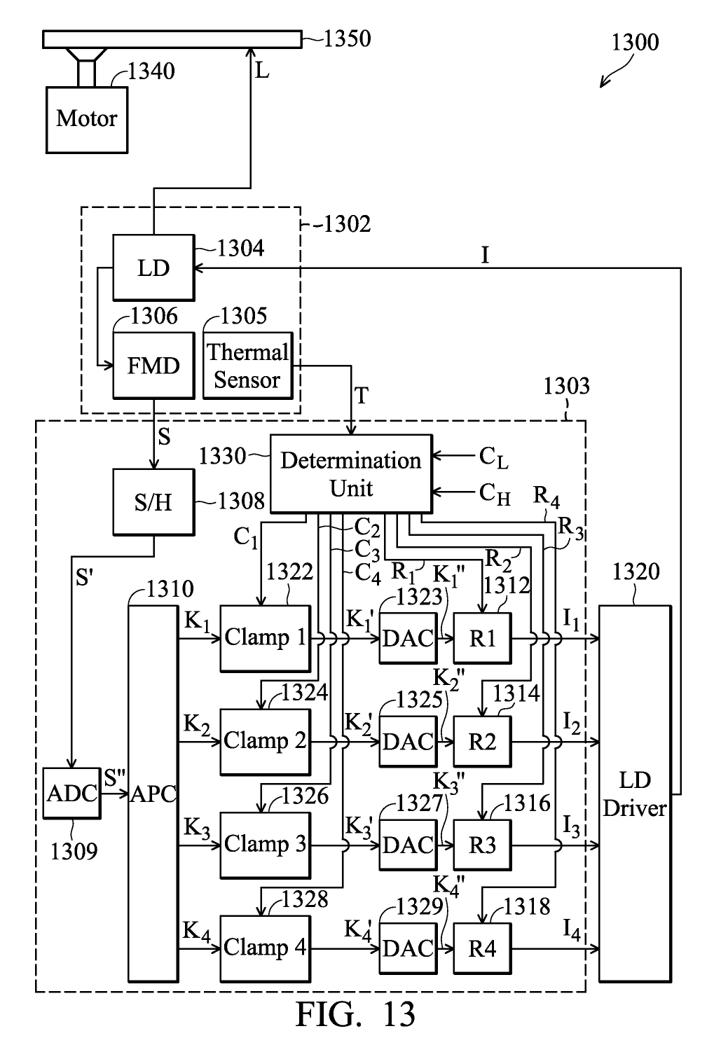

Please refer to FIG. 13, which shows a block diagram of another optical disk drive 1300 which combines the clamp value adjustment with the transformation characteristic adjustment according to an embodiment of the present invention. The clamps and the resistors are adjustable. The laser diode and the pickup head are properly protected during operations such as recording and/or reading process. The performance of the optical disk drive can therefore be improved.

Although four channels (i.e. four clamps, four DACs, and four Voltage-to-current transforming circuits) are shown in above embodiments, please note that this is for illustrative purpose only, rather than limitations. Driving circuits that have other number of channels still fall within the scope of the present invention. Moreover, the temperature of the laser diode is not limited to be obtained from the thermal sensor; other devices capable of obtaining information of temperature could be utilized as well.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving circuit for generating a power control signal for driving a laser diode of a pickup head, comprising:
an automatic power control (APC) module, for generating at least one power control signal;
a clamp value determination unit, for dynamically determining at least one clamp value corresponding to the power control signal when the pickup head accesses an optical storage medium; and
a clamp circuit, for clamping the power control signal according to the clamp value to obtain a clamped power control signal.

2. The driving circuit as claimed in claim 1, wherein the clamp value determination unit dynamically determines the clamp value according to temperature of the pickup head.

3. The driving circuit as claimed in claim 2, wherein the clamp value determination unit determines the clamp value corresponding to the temperature according to linear interpolation based on a first predetermined clamp value corresponding to a low temperature and a second predetermined clamp value corresponding to a high temperature.

4. The driving circuit as claimed in claim 3, wherein the linear interpolation is according to the following algorithm:
$${C}_{k} = {C}_{L} + \frac{{C}_{H} - {C}_{L}}{{T}_{H} - {T}_{L}} \times ( {T}_{K} - {T}_{L} ) ,$$
wherein C_{K} is the clamp value corresponding to the temperature T_{K}, C_{L} is the first predetermined clamp value corresponding to the low temperature T_{L}, and C_{H} is the second predetermined clamp value corresponding to the high temperature T_{H}.

5. The driving circuit as claimed in claim 2, wherein the clamp value determination unit determines the clamp value by searching a lookup table according to the temperature, wherein the lookup table stores a list of predetermined clamp values corresponding to a series of temperatures.

6. The driving circuit as claimed in claim 2, wherein the clamp value determination unit determines the clamp value further according to a recording speed.

7. The driving circuit as claimed in claim 6, wherein the clamp value determination unit determines a target recording power level according to the recording speed, determines a low target clamp value at the target recording power level corresponding to a low temperature, determines a high target clamp value at the target recording power level corresponding to a high temperature, and determines the clamp value corresponding to the temperature, the low target clamp value and the high target clamp value.

8. The driving circuit as claimed in claim 2, wherein the pickup head comprises:
a thermal sensor, for detecting the temperature of the pickup head to obtain a temperature signal sent to the clamp value determination unit.

9. The driving circuit as claimed in claim 1, further comprising:
an analog-to-digital converter (ADC), coupled between the pickup head and the automatic power control module, for converting a feedback signal generated by the pickup head from an analog format to a digital format.

10. The driving circuit as claimed in claim 9, further comprising:
a digital-to-analog converter (DAC), coupled to the clamp circuit, for converting the clamped power control signal from the digital format to the analog format.

11. The driving circuit as claimed in claim 9, further comprising:
a digital-to-analog converter (DAC), coupled between the automatic power control module and the clamp circuit, for converting the power control signal from the digital format to the analog format.

12. The driving circuit as claimed in claim 1, wherein the clamp value determination unit dynamically determines the clamp value according to a recording speed.

13. The driving circuit as claimed in claim 1, wherein the clamp value determination unit dynamically determines the clamp value according to a target recording power.

14. A driving circuit for generating a power control signal for driving a laser diode of a pickup head, comprising:
an automatic power control (APC) module, for generating at least one power control signal;
a determining unit, for dynamically determining a transformation characteristic when the pickup head accesses an optical storage medium; and
a voltage-to-current transforming circuit, for transforming the power control signal from a voltage format to a current format according to the transformation characteristic to generate a transformed power control signal.

15. The driving circuit as claimed in claim 14, wherein the voltage-to-current transforming circuit comprises a resistive element, and the determining unit dynamically determines a resistance of the resistive element when the pickup head accesses an optical storage medium.

16. The driving circuit as claimed in claim 14, wherein the determining unit dynamically determines the transformation characteristic according to temperature of the pickup head, a recording speed, or a target recording power.

17. A method for generating a power control signal for controlling laser power of a laser diode of a pickup head, comprising:
generating at least one power control signal;
dynamically determining at least one clamp value corresponding to the power control signal when the pickup head accesses an optical storage medium; and
clamping the power control signal according to the clamp value to obtain a clamped power control signal.

18. A method for generating a power control signal for controlling laser power of a laser diode of a pickup head, comprising:
generating at least one power control signal;
dynamically determining a transformation characteristic when the pickup head accesses an optical storage medium; and
transforming the power control signal from a voltage format to a current format according to the transformation characteristic to generate a transformed power control signal.

19. A driving circuit for generating a power control signal for driving a laser diode, comprising:
an automatic power control (APC) module, for generating at least one power control signal;
a clamp value determination unit, for determining at least one clamp value corresponding to the power control signal according to temperature of the laser diode; and
a clamp circuit, for clamping the power control signal according to the clamp value to obtain a clamped power control signal.

20. A driving circuit for generating a power control signal, comprising:
an automatic power control (APC) module, for generating at least one power control signal;
a clamp value determination unit, for determining at least one clamp value corresponding to the power control signal according to a target recording power; and
a clamp circuit, for clamping the power control signal according to the clamp value to obtain a clamped power control signal.
